(19) United States
(12) Patent Application Publication
(10) Pub. No.: US 2026/0015966 A1
(43) Pub. Date: Jan. 15, 2026

(54) PRECHAMBER SPARK PLUG

(71) Applicant: Robert Bosch GmbH, Stuttgart (DE)

(72) Inventors: Paul Justus Sieffert, Stuttgart (DE); Matthias Blankmeister, Heiligenhaus (DE); Moritz Wenk, Stuttgart (DE)

(21) Appl. No.: 18/995,426

(22) PCT Filed: Jun. 26, 2023
(86) PCT No.: PCT/EP2023/067310

§ 371 Date: Jan. 16, 2025

(30) Foreign Application Priority Data
Jul. 27, 2022 (DE) 10 2022 207 692.3

(51) Int. Cl. F02B 19/12; F02B 19/16; H01T 13/06; H01T 13/39

(52) U.S. Cl. CPC F02B 19/12; F02B 19/16; H01T 13/06; H01T 13/39

(57) ABSTRACT

A prechamber spark plug. The prechamber spark plug includes: a housing, a central electrode a ground electrode, wherein the central electrode and the ground electrode are arranged in a prechamber, an isolator, and a cap hat closes the prechamber in the direction of a combustion chamber wherein the isolator has a lateral wall region that extends coaxially to a central axis of the prechamber spark plug, an end region that lies substantially perpendicular to the central axis and from which the central electrode protrudes, and a connection region that connects the lateral wall region to the end region and has a defined distance between the central electrode and ground electrode.

### BACKGROUND INFORMATION

The present invention relates to a prechamber spark plug having improved ignition properties and a longer service life and in particular a reduced risk of sparking of weld seams of the prechamber spark plug.

Prechamber spark plugs are described in the related art in different designs. A prechamber of the prechamber spark plug is usually defined by a housing region and a cap. However, by using the cap, the ignitable mixture cannot come into direct contact with the spark gap and be ignited. For this reason, what are known as cap holes are usually provided in the cap to ensure that an ignitable mixture reaches the prechamber and in particular the ignition gap between a central electrode and a ground electrode. However, one problem here is that manufacturers of internal combustion engines usually have different designs and layout conditions, in particular with regard to the position of a prechamber spark plug in relation to a fuel injection jet. Therefore, the cap of the prechamber spark plug in particular must be positioned precisely to achieve optimal gas exchange within the prechamber. This often results in a risk of sparking of the weld seams of the prechamber spark plug if the position of the cap and therefore the gas exchange for introducing an ignitable mixture is not optimal. However, this can significantly reduce the service life of the prechamber spark plug.

### SUMMARY

The prechamber spark plug according to the present invention may have an advantage that, by adhering to defined parameters of components of the prechamber spark plug, a targeted flow in the prechamber can be achieved, which leads to better ignition in the prechamber. In particular, a spark location can be specifically directed away from weld seams or the like, which significantly extends the service life of the prechamber spark plug. According to the present invention, an increase in flow velocity within the prechamber can also be realized, which leads to a more turbulent flow in the prechamber and improved ignition at the time of ignition. In particular, ignitability can be achieved by stronger spark deflection and a resulting increase in volume between the spark and the combustible mixture in the prechamber.

According to an example embodiment of the present invention, this may be achieved in that the prechamber spark plug has a housing, a central electrode, and a ground electrode. The central electrode and the ground electrode are arranged in a prechamber. Furthermore, the prechamber spark plug comprises an isolator and a cap that closes off the prechamber in the direction of a combustion chamber of an internal combustion engine. The isolator has a lateral wall region that is parallel to a central axis X-X of the prechamber spark plug, an end region that is substantially perpendicular to the central axis and on which the central electrode is arranged and in particular protrudes, and a connection region that connects the wall region to the end region. A first point K is defined at a transition between the lateral wall region and the connection region of the isolator. A second point M is defined at a transition between the connection region and the end region of the isolator. A third point I is defined at a free end of the central electrode, the third point I being the point at the free end of the central electrode that is farthest from the ground electrode. A fourth point P is defined at a free end of the ground electrode. The fourth point P is the point at the free end of the ground electrode that is farthest away from the central electrode. Furthermore, there is a first straight line KI that passes through the first point K and the third point I. A second straight line KP passes through the first point K and the fourth point P. There is an angle bisector W between the first and second straight lines. A third straight line KM passes through the first point K and the second point M on the isolator. An angle α between the angle bisector W and the third straight line KM is in a range of +20 ≤α≤−20°. Thus, the angle α is in a range of +20° around the angle bisector W. By adhering to these geometric rules, greater spark deflection of the spark between the central electrode and the ground electrode can be achieved, resulting in an increase in volume between the spark and the ignitable mixture in the prechamber. This allows for better ignition of the ignitable mixture in the prechamber.

Preferred developments of the present invention are disclosed herein.

Preferably, according to an example embodiment of the present invention, the angle α is in a range of +15°≤α≤−15° and more preferably in a range of +10°≤α≤−10° and more preferably in a range of +5°≤α≤−5° and in particular is 0°. Particularly good expanding flame fronts inside the combustion chamber are achieved when the angle bisector W and the third straight line KM coincide and the angle x is therefore 0°.

According to a further preferred embodiment of the present invention, a distance Q between the third point I and the fourth point P is in a range of 1 mm to 3 mm and preferably in a range of 1.5 mm to 2.5 mm.

Further preferably, according to an example embodiment of the present invention, the prechamber spark plug has a plurality of ground electrodes, wherein a fourth point P is present at each of the plurality of ground electrodes and the geometric specifications according to the present invention are met for all ground electrodes with respect to a centered, middle central electrode.

According to a further preferred embodiment of the present invention, the ground electrode has a cylindrical noble metal pin that defines the free end of the ground electrode and/or the central electrode has a cylindrical noble metal pin that defines the free end of the central electrode.

Preferably, according to an example embodiment of the present invention, the connection region on the isolator between the first point K and the second point M is a straight line in section and/or a convex curve in section and/or a concave curve in section. Particularly preferably, the connection region begins at point K with a concave curve that changes to a convex curve at an inflection point and ends at point M of the isolator that is located at the transition between the end region perpendicular to the central axis X-X and the connection region.

In order to achieve even better flow guidance in the prechamber, the prechamber spark plug preferably has a flow guide element on an inner wall of the housing.

The flow guide element is preferably a region protruding radially inward from the inner wall, for example a material accumulation.

The flow guide element is preferably arranged below the ground electrode. If a plurality of ground electrodes are provided, a flow guide element is preferably arranged under each ground electrode.

Particularly preferably, the flow guide element ends at or near a plane E that is perpendicular to a central axis X-X of the prechamber spark plug and passes through the second point M on the isolator.

According to a preferred example embodiment of the present invention, the flow guide element comprises a recess in the inner wall of the housing, preferably below the ground electrode. The recess is preferably formed at the level of the connection region of the isolator and preferably ends at the level of the first point K. The flow guide element preferably comprises a material accumulation and a recess.

The prechamber spark plug preferably has exactly one central electrode that is arranged in a central axis of the prechamber spark plug.

### BRIEF DESCRIPTION OF THE DRAWINGS

In the following, preferred exemplary embodiments of the present invention are described in detail below with reference to the figures.

FIG. 1 is a schematic sectional view of a prechamber spark plug according to a first exemplary embodiment of the present invention.

FIG. 2 is a schematic sectional view of a prechamber spark plug according to a second exemplary embodiment of the present invention.

FIG. 3 is a schematic sectional view of a prechamber spark plug according to a third exemplary embodiment of the present invention.

### DETAILED DESCRIPTION OF EXAMPLE EMBODIMENTS

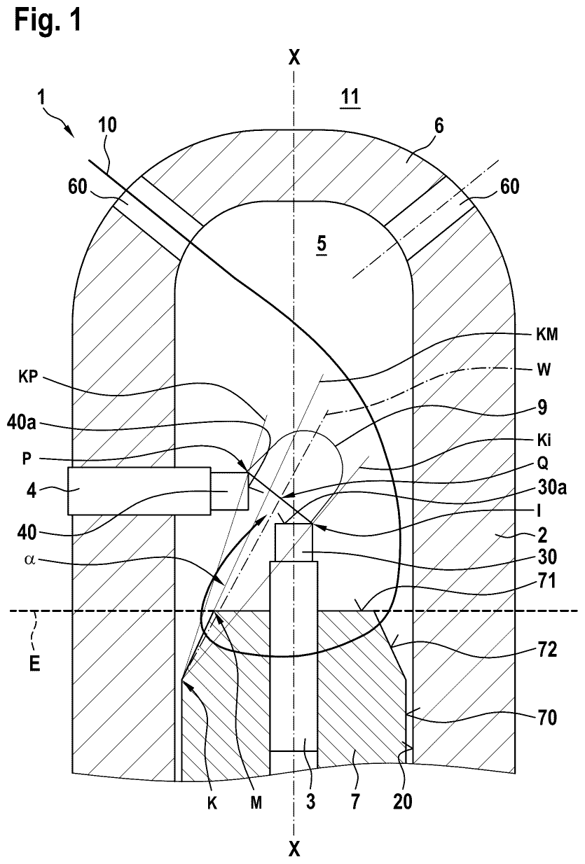

In the following, a prechamber spark plug 1 according to a first preferred exemplary embodiment of the present invention is described in detail, with reference to FIG. 1.

As can be seen from FIG. 1, the prechamber spark plug 1 comprises a housing 2 and a cap 6. The housing 2 and the cap 6 together define a prechamber 5.

A plurality of cap holes 60 for gas exchange between the prechamber 5 and a combustion chamber 11 are provided in the cap 6.

The prechamber spark plug 1 further comprises a central electrode 3 and a ground electrode 4. The central electrode 3 is arranged in a central axis X-X of the prechamber spark plug. The ground electrode 4 is arranged at a right angle in relation to the central electrode 3 in the housing.

The central electrode 3 comprises a cylindrical noble metal pin 30 on which a flat, planar free end 30a is defined. The ground electrode 4 also comprises a cylindrical noble metal pin 40 on which a flat, free end 40a is defined.

The ground electrode 4 is secured in the housing 2, for example by means of a welded connection.

The central electrode 3 is arranged in an isolator 7 that electrically isolates the housing 2 and thus the ground electrode 4 from the central electrode 3. The central electrode 3 is connected in a conventional manner to an electrical connection of the prechamber spark plug (not shown).

The prechamber spark plug 1 is therefore arranged directly on the combustion chamber 11 of an internal combustion engine. By using the cap 6, an ignitable mixture that forms in the combustion chamber 11 cannot come into direct contact with a spark gap between the central electrode 3 and the ground electrode 4. Therefore, the prechamber spark plug and in particular the cap 6 must be aligned such that a gas flow 10, which is shown schematically in FIG. 1, reaches into the prechamber 5 and in particular into the spark gap between the central electrode and the ground electrode in order to provide an ignitable mixture there when an ignition spark occurs.

As can be further seen from FIG. 1, the isolator 7 has a lateral wall region 70, a front end region 71 and a connection region 72 that connects the wall region 70 to the end region 71. In section, the connection region 72 is a straight line. Different embodiments of the connection region can also be concave or convex. Therefore, the isolator 7 has substantially the shape of a truncated cone at its end facing the prechamber 5.

The lateral wall region 70 runs parallel to an inner wall 20 of the housing 2. Therefore, the inner wall 20 and the lateral wall region 70 are cylindrical. Alternatively, the wall region 70 of the isolator lies directly on the inner wall 20.

As can be further seen from FIG. 1, a first point K is defined at a transition between the lateral wall region 70 and the connection region 72.

A second point M is defined at a transition between the connection region 72 and the end region 71.

A third point I is defined at a free end of the central electrode 3, more precisely at the cylindrical noble metal pin 30, wherein the third point I is the farthest point of the free end 30a of the central electrode 3 from the ground electrode 4.

A fourth point P is defined at a free end 40a of the ground electrode 4. The fourth point P is the point on the cylindrical noble metal pin 40 at its free end 40a that is farthest away from the central electrode.

Furthermore, the prechamber spark plug 1 comprises a first straight line KI through the first point K and the third point I.

Furthermore, a second line KP is defined by the first point K and the fourth point P.

Furthermore, there is an angle bisector W between the first line KI and the second line KP.

A third straight line KM passes through the first point K and the second point M on the isolator 7.

An angle α between the angle bisector W and the third straight line KM on the isolator 7 is preferably in a range of +20°≤α≤−20° and in this exemplary embodiment is 5°. The angle α is positive if the straight line KM passes between the points P and I.

Furthermore, a distance Q is defined between the third point I on the central electrode and the fourth point P on the ground electrode. The angle bisector W cuts the distance Q in half.

As indicated in FIG. 1, a spark 9 generated between the central electrode 3 and the ground electrode 4 can thus be deflected due to the gas flow 10 in the direction of the cap 6. Thus, the spark 9 is now deflected by the gas flow 10 from its point of origin between the central electrode 3 and the ground electrode 4, which is usually the shortest distance between the central electrode 3 and the ground electrode 4, over the duration of combustion. The targeted gas flow 10 also results in an increase in flow velocity within the prechamber 5, which has an advantageous effect on the acceleration of combustion because it creates greater turbulence within the prechamber 5. The gas flow 10 ensures that the spark does not spread in the direction of a weld seam that may be present between the ground electrode 4 and the inner wall 20 of the housing 2. This significantly extends the service life of the spark plug.

Thus, by the targeted expansion of the spark 9 by means of the gas flow 10, an increase in the volume of the flame front in the prechamber 5 can be achieved, which has an advantageous effect on the ignition within the prechamber 5 and therefore on the burner jets that then emerge through the cap holes 60 to ignite the combustible mixture in the combustion chamber 11.

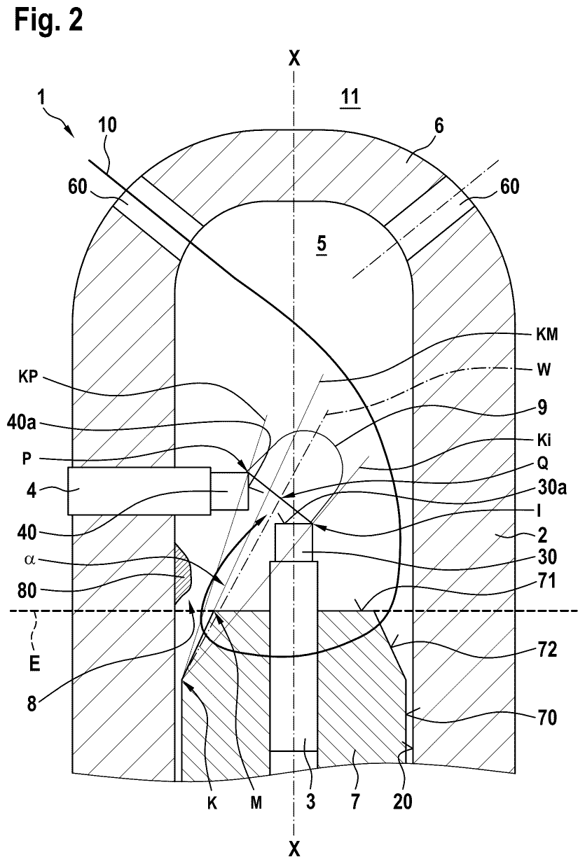

FIG. 2 shows a prechamber spark plug 1 according to a second exemplary embodiment of the present invention. Identical or functionally identical parts are denoted by the same reference signs as in the first exemplary embodiment.

As can be seen from FIG. 2, the second exemplary embodiment substantially corresponds to the first exemplary embodiment, wherein, in contrast to the first exemplary embodiment, in the second exemplary embodiment a flow guide element 8 is arranged on the inner wall 20 of the housing 2. In this exemplary embodiment, the flow guide element 8 is a material accumulation 80. The flow guide element 8 is arranged below the ground electrode 4. The flow guide element 8 is provided such that it lies between a plane E, in which the end region 71 of the isolator 7 lies, and the ground electrode 4. The flow guide element 8 ends at the plane E. The flow guide element 8 is aerodynamically shaped in order to achieve a deflection of the gas flow 10 in the direction of the spark gap between the central electrode 3 and the ground electrode 4. This allows even more targeted guidance of the gas flow 10 to be achieved.

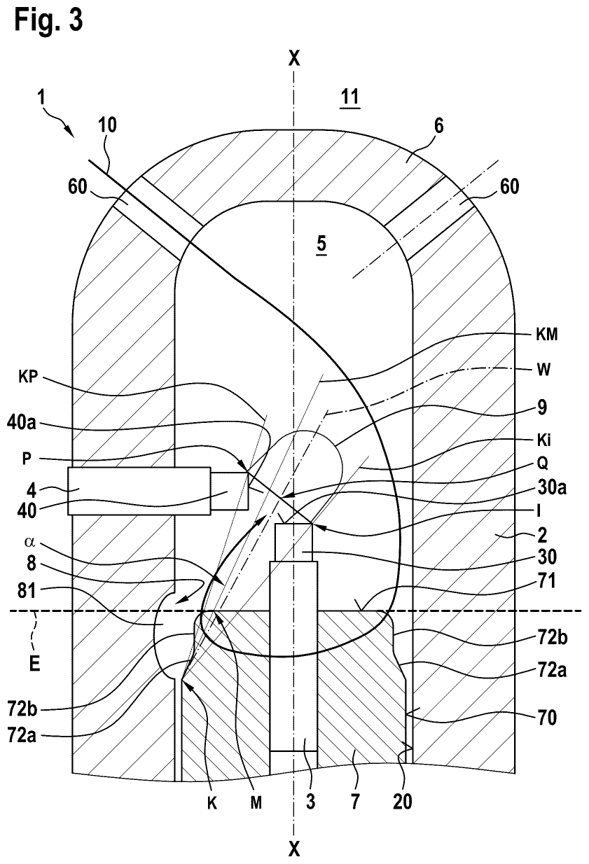

FIG. 3 shows a prechamber spark plug 1 according to a third exemplary embodiment of the present invention. Identical or functionally identical parts are denoted by the same reference signs as in the above-described exemplary embodiments.

The third exemplary embodiment substantially corresponds to the second exemplary embodiment and also has a flow guide element 8. However, the flow guide element 8 of the third exemplary embodiment is a recess 81 on the inner wall 20 of the housing 2. The recess 81 is again formed below the ground electrode 4. The recess 81 also has the function of redirecting the gas flow 10 in order to redirect the gas flow 10 in an improved manner into the ignition gap between the central electrode 3 and the ground electrode 4. Otherwise, this exemplary embodiment corresponds to the second exemplary embodiment, so that reference can be made to the description given there.

1-10. (canceled)

11. A prechamber spark plug, comprising:
a housing;
a central electrode;
a ground electrode, wherein the central electrode and the ground electrode are arranged in a prechamber;
an isolator; and
a cap that closes the prechamber in a direction of a combustion chamber;
wherein the isolator has a lateral wall region that extends substantially coaxially to a central axis of the prechamber spark plug, an end region that lies substantially perpendicular to a central axis and from which the central electrode protrudes, and a connection region that connects the lateral wall region to the end region;
wherein a first point K is defined at a transition between the lateral wall region and the connection region;
wherein a second point M is defined at the transition between the connection region and the end region;
wherein a third point I is defined at a free end of the central electrode that is a point farthest from an end region of the ground electrode;
wherein a fourth point P is defined at a free end of the ground electrode that is a point farthest from the free end of the central electrode;
wherein a first straight line KI passes through the first point K and the third point I;
wherein a second straight line KP passes through the first point K and the fourth point P;
wherein an angle bisector W passes between the first straight line KI and the second straight line KP,
wherein a third straight line KM passes through the first point K and the second point M on the isolator; and
wherein an angle α between the angle bisector W and the third straight line KM is in a range of +20°≤α≤−20°.

12. The prechamber spark plug according to claim 11, wherein the angle α is in a range of +15°≤α≤−15°.

13. The prechamber spark plug according to claim 11, wherein a distance Q between the third point I and the fourth point P is in a range of 1 mm to 3 mm.

14. The prechamber spark plug according to claim 11, wherein a plurality of ground electrodes are arranged on the housing, each having the fourth point P.

15. The prechamber spark plug according to claim 11, wherein: (i) the ground electrode has a noble metal pin on which the free end is defined and/or (ii) the central electrode has a noble metal pin on which the free end is defined.

16. The prechamber spark plug according to claim 11, wherein the connection region on the isolator between the first point K and the second point M is straight in section and/or is convex in section and/or is concave in section and/or is freely selectable in section.

17. The prechamber spark plug according to claim 11, wherein a flow guide element is arranged on an inner wall of the housing.

18. The prechamber spark plug according to claim 17, wherein the flow guide element is a region protruding radially inward from the inner wall of the housing.

19. The prechamber spark plug according to claim 17, wherein the flow guide element is arranged on a plane E or between the ground electrode and the plane E, wherein the plane E runs perpendicular to the central axis of the prechamber spark plug and passes through the second point M on the isolator.

20. The prechamber spark plug according to claim 17, wherein the flow guide element includes a recess in the inner wall of the housing.
